(19) United States
(12) Patent Application Publication
(10) Pub. No.: US 2018/0130126 A1
(43) Pub. Date: May 10, 2018

(54) METHOD AND SYSTEM FOR AUTOMATICALLY GENERATING SECURITY LENDING MATCHES BETWEEN INDIVIDUAL INVESTORS AND FINANCIAL INSTITUTIONS

(71) Applicant: Sharegain Ltd., London (GB)

(72) Inventors: Boaz YAARI, London (GB); Liad Amit, Netanya (IL)

(21) Appl. No.: 15/347,807

(22) Filed: Nov. 10, 2016

(51) Int. Cl. G06Q 40/02; G06Q 40/06

(52) U.S. Cl. CPC G06Q 40/025; G06Q 40/06

(57) ABSTRACT

A method and a system for automatically generating security lending matches between individual investors and financial institutions are provided herein. As most individual investors lack the time, expertise, or resources to maximize the full potential and value of their investment portfolio on a daily basis, embodiments of the present invention overcome the drawbacks of currently available services in the securities lending domain. This is being achieved through a unique model and process that turns securities lending from a complex and limited offering to an intelligently simple and accessible financial service, which an owner of securities can activate, fully customize and control on an ongoing basis in a simple intuitive manner.

### FIELD OF THE INVENTION

The present invention relates generally to the field of computer implemented financial services, and more particularly to implementing security lending deals generator.

### BACKGROUND OF THE INVENTION

Securities lending (sometimes referred to as stock lending) is a well-established activity in the financial markets in which one party lends his or her securities to another, for a fee, over a discrete period of time, on a collateralized basis. During the term of the loan, lenders retain all the ownership benefits for the loaned securities, from dividends to rights' issue, save for the right to vote. Typically, the lender retains a right to terminate the transaction and recall the loaned security at any given time. The terms of the loan are governed by a securities lending agreement which requires the borrower to provide the lender with collateral, in the form of cash or non-cash securities, of value equal to or greater than the loaned securities plus agreed upon margin. Non-cash refers to the subset of collateral that is not pure cash, including equities, government bonds, corporate bonds, Exchange Traded Funds and other products. The loan agreement is a contract enforceable under relevant law, which is often specified in the agreement.

Securities lending play an important role in improving efficiency and enhancing the liquidity of securities' markets by ensuring settlement of problematic trades and facilitating market making, derivatives trading and hedging activities. It is also a key enabler of trading strategies that involve short selling a security, such as Pairs Trading or various Arbitrage strategies.

Typically, key lenders of securities include almost exclusively institutional investors such as mutual funds, insurance companies, pension plans and other large investment managers. This is due to the nature and size of their investments (big holdings for relatively long term). Borrowers tend to be Prime Brokers (PBs), Hedge Funds (HFs) and various trading units within banks.

Currently, the estimated value of the global balance of lendable securities is around US $15,000 Billion, out of which currently on-loan value averages around US $2,000 Billion with corresponding lending fees in 2015 exceeding US $8.0 Billion. Lending fees, as the payment for the loan, are negotiated by the parties and quoted as an annualized percentage of the value of the loaned securities. Lending fees vary significantly from a few bps (One basis point equals 0.01%) to above 100% annually and differentiate by the demand for borrowing and the scarcity of supply, which are very much macro and micro dependent.

Paradoxically, even though every owner of stocks, bonds and ETFs has the right to lend them, in reality only a few have the ability to do so. Unlike other sub-sectors within Capital Markets that became standardized and accessible to most investors in the last few years, securities lending has been and still is, mostly confined to an elite cadre of institutional investors.

Individual investor who wishes to lend its securities, faces high barriers to entry such as: minimum portfolio size, required experience and IT, expertise in collateral management, finding the right bank/broker that has securities lending arrangements and then transferring his/her portfolio to it.

Although a few financial institutions offer internal securities lending programs to their customers as a side product to managing their portfolios, these securities lending programs are very limited. Most of these programs face their lenders customers as principal borrowers (opposing side to every loan), and by that create an inherent conflict of interest (in lending fees, lenders' hierarchy and collateral management). It should be noted that these internal securities lending programs do not offer their individual customers the ability to customize lending preferences, choose their counterparties or the transparency regarding the life-cycle management of every loan. Furthermore, these internal programs enable their clients to lend securities from their specific account only and cannot offer an aggregative single solution for clients with multiple accounts at multiple banks/brokers.

### SUMMARY OF THE INVENTION

Some embodiments of the present invention provide a fully automated, simple and transparent, securities lending agency service implemented as a computerized platform used by individual investors.

Advantageously, some embodiments of the present invention enable individual investors to enhance the returns on their long term investments, by lending certain securities of their choice, directly from their various investment accounts at their bank/s or broker/s, to borrowers, in a simple manner, with the ability to set lending terms of their choice and control the process, without having to manage it.

In addition, some embodiments of the present system empower individual investors by enabling them to group anonymously with other individuals, and form a joint lending pool of their securities under lending terms with equal rights. By doing so, they receive the same opportunities as institutional investors to meet borrowers' demand and enjoy industry solutions such as Triparty collateral management services and other capabilities, which are out of the reach of individuals.

Effectively, a server associated with a party other than the owners of the securities (lenders) and the borrowers, will act as an agent of lenders, aggregating individual investors' holdings and enable them for the first time to enjoy from “the hidden value of securities lending” in a practically risk free manner, much like large institutional investors that are engaged in securities lending enjoy today.

Advantageously, some embodiments of the present invention disconnect the linkage between security lending and investment account management, thereby enabling individual investors to fulfill their rights as the true beneficial owners of the securities, not being bound by the ability or willingness of their bank/broker to offer them a securities lending service. This is in clear contrast to the few currently available internal programs, in which investors who wish to earn extra income from lending securities are unable to set their own preferences and receive full control and transparency over their lending activity.

Further advantageously, some embodiments of the present invention enable clustering of lendable securities from various categories of individual clients, from retail to Ultra High Net Worth individuals, thus creating unique fair and equitable opportunity for all individual investors

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a block diagram illustrating non-limiting exemplary architecture of a system in accordance with embodiments of the present invention;

FIG. 2 is a block diagram illustrating non-limiting exemplary architecture of an aspect of the system in accordance with embodiments of the present invention; and

FIG. 3 is a high level flowchart illustrating non-limiting exemplary method in accordance with embodiments of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following description, various aspects of the present invention will be described. For purposes of explanation, specific configurations and details are set forth in order to provide a thorough understanding of the present invention. However, it will also be apparent to one skilled in the art that the present invention may be practiced without the specific details presented herein. Furthermore, well known features may be omitted or simplified in order not to obscure the present invention.

Unless specifically stated otherwise, as apparent from the following discussions, it is appreciated that throughout the specification, discussions utilizing terms such as “processing,” “computing,” “calculating,” “determining,” or the like, refer to the action and/or processes of a computer or computing system, or similar electronic computing device, that manipulates and/or transforms data represented as physical, such as electronic, quantities within the computing system's registers and/or memories into other data similarly represented as physical quantities within the computing system's memories, registers or other such information storage, transmission or display devices.

As most individual investors lack the time, expertise, or resources to maximize the full potential and value of their investment portfolio on a daily basis, some embodiments of the present invention overcome the drawbacks of currently available services in the securities lending domain. This is being achieved through a unique model and process that turns securities lending from a complex and limited offering to an intelligently simple and accessible financial service, which an owner of securities can activate, fully customize and control on an ongoing basis in a simple intuitive manner.

Advantageously, some embodiments of the present invention create a new standard in agent-lenders' offering that aligns with the interests of individual investors. Specifically, embodiments of the present invention provide full transparency, equality and fairness in lenders' hierarchy, greater revenue sharing, full control over lendable securities, access to lending data and enhanced protection via top-tier Tri-party collateral manager and strong credit rated borrowers.

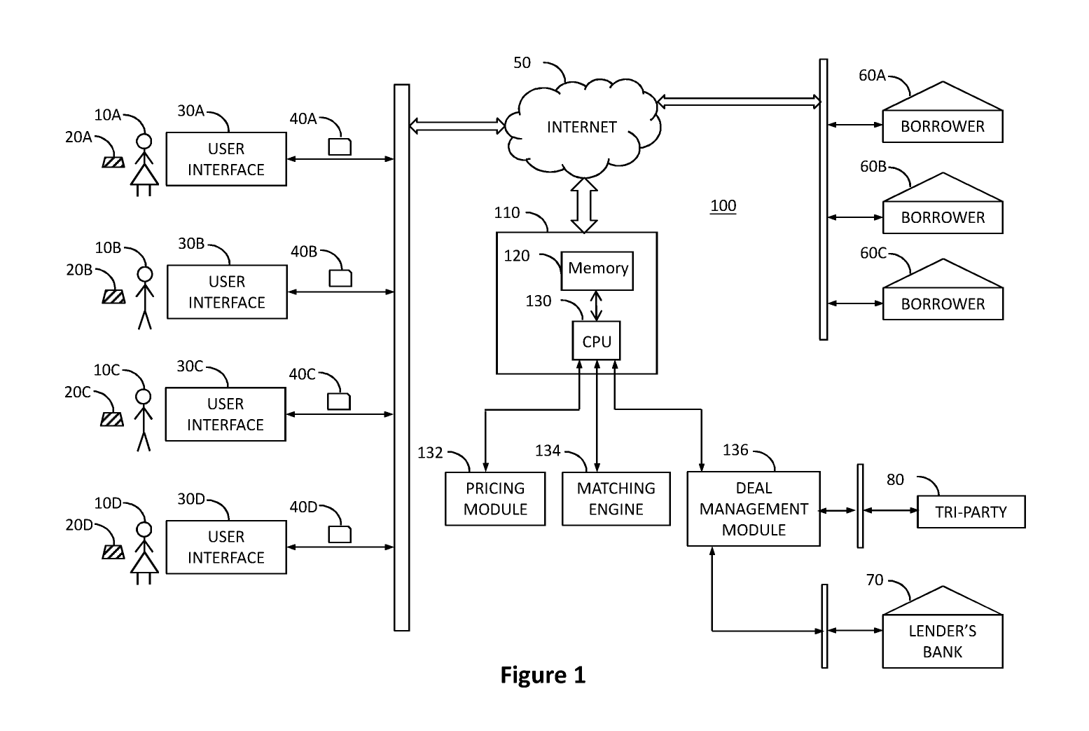

FIG. 1 is a block diagram illustrating non-limiting exemplary architecture of a system 100 in accordance with embodiments of the present invention. System 100 may include a plurality of user interface units 30A-30D associated with lenders 10A-10D being owners of lendable securities 20A-20D. User interface units 30A-30D are configured to receive a plurality of requests 40A-40D to lend securities using at least one of lendable security 20A-20D associated with respective lending terms set by one of owners 10A-10D of the lendable security.

System 100 includes a server 110 connected via a network such as the Internet 50 to user interface units 30A-30D. Server 110 may be implemented via a CPU 130 and a memory 120 on which software modules are executed. Server 110 may include a pricing module 132 configured to generate price requirements for the plurality of the securities that are offered for lending by the lenders. Server 110 may further include a matching engine 134 configured to cluster a plurality of lendable securities and match between at least one borrower and a plurality of lenders of a same cluster, wherein the matching is based on maximizing the lending fee potential for the owners while meeting the respective lending terms, the predefined criteria, and further requirements applied by a party other than the owners 10A-10D or the borrowers 60A-60C. This matching engine embodiment is also reflected by an Enhanced First In First Out (EFIFO) module to create fair and equitable allocations among lenders.

According to some embodiments of the present invention, the method may further include a deal management module 136 configured to automatically manage the life-cycle of a plurality of lending transactions between the matched borrowers and the respective owners of the loaned securities.

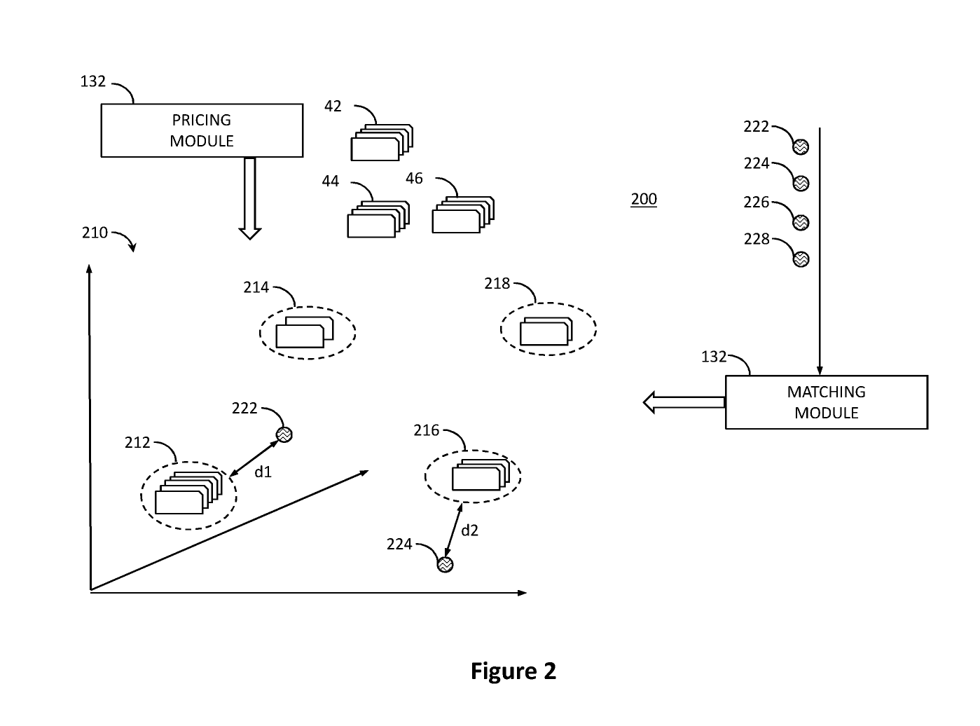

FIG. 2 is a block diagram illustrating non-limiting exemplary architecture of an aspect of the system in accordance with some embodiments of the present invention. Pricing module 132 can receive the plurality of securities' lending options 42-46. Pricing module attaches a score (e.g., price/lending rate) to each of lending options 42-46 and stores them as aggregators or clusters of similar offers or similar loaned security. Matching module retrieves the available financial institutions, which are available as borrowers 222-228. Then, by way of example, over an N-dimensional space 210, shortest distance between borrowers (e.g., 222) and cluster 212 of similar security lending offers, such as di, is allocated and matched. Thus, security lending can be used by individual investors.

Following below is a non-limiting example illustrating a possible sequence of actions in accordance with some embodiments of the present invention.

Sign up: An individual investor wishing to activate the service in accordance with some embodiments of the present invention may initiate a request, indicating a desire to lend his or her securities from his or her one of a plurality of bank and/or brokerage accounts, and provide all the necessary identity verifications and any other details and authorizations to enable a third party service provider (other than the owners and the potential borrowers) to set the relevant communication means with his or her bank/broker service provider and act in his or her behalf.

Ownership and lending rights checkup: The system establishes a connection with the individual investor's bank/broker in order to:
Validate ownership and ability to lend his or her securities.
Communicate and Transfer securities' lending instructions with his or her bank/broker (receiving portfolio data and transferring instructions) will be carried out in accordance with the market standards (e.g. direct connectivity and/or SWIFT))

Portfolio analysis: the system according to some embodiments of the present invention scans the customer's portfolio (one or more) for lendable securities, analyzes the possible returns from securities lending, and notifies the customer with the results. Based on: portfolio composition (securities types and quantities), transaction costs (fees charged by the customers' bank/broker for data access, receiving and executing instructions) and potential returns from lending its securities (incorporating current lending fees and past performance, and internally analyzed market data) the customer will be able to decide if it is worth the effort to setup and activate the computerized service, in accordance with embodiments of the present invention, on his or her portfolio. Advantageously, some embodiments of the present invention may offer the client to periodically scan and reconcile the portfolio in case of changes in its holdings.

Offering lendable securities to borrowers: in order to eliminate the complexity, time consuming and labor-intensive processes associated with the negotiation stage of securities lending transactions with borrowers, the customer sets his or her lending terms in advance on the computerized platform in accordance with some embodiments of the present invention. In order to simplify this part, the system will enable the user to view and select various default settings according to his/her appetite for initial engagement with the computerized platform.

Choosing lendable securities: The system enables the customer to choose all/certain securities and set a quantity limitation (percentage or units) for each security or on a portfolio level. The system will not enable the user to offer to lend 100% of certain security and by so enable him to keep track on his investment from his bank/brokerage account (corporate events, security price/return, etc.) in the same manner he is used to.

In addition, the system will set an automatic lending limit according to the customer's classification based on his knowledge and expertise in securities lending and investments as a whole.

Minimum lending return: The system will enable the user to set his minimal desired return and eliminates the hassle and latency that is involved with negotiating a price with multiple counterparties.

Loan period: the system will enable the user to set specific loan term or set an open-end loan.

Recall terms: The system will enable the user to set automatic recall functionality in case of certain events. For example, an automatic recall can be triggered in instances of non-mandatory corporate actions, aggressive change in security's price and the like. By setting recall terms in advance, the system eliminates the difficulty involved in managing and keeping track on loans.

Borrowers of choice: the system will enable the user to set conditions and/or approve certain borrowers.

Equality of lenders—the system will virtually display the investors' lendable securities in an aggregated pool (aggregating investors securities with similar lending terms) and use a proprietary matching engine based on an Enhanced First In First Out (EFIFO) lending order rule that is based on providing optimal allocations, given predefined lending and settlement criteria, while maintaining fair and equitable allocations as well as calculating a minimum lending return that ensures that clients' securities are only lent when the expected return (after fees) will be positive.

Approval of requests—the system will enable the lender either to allow it to automatically approve matched transactions, or to pre approve each matched transaction.

Maximize the returns—a server independent of the owners and the potential borrowers will set lending fees to each security by using a proprietary pricing model

Deal initiation—Once a borrower places an order to borrow a certain security and received a matched approval from the system, he will need to place a collateral at the Triparty Collateral manager. The system will verify the collateral is in place as a prerequisite to initiating the loan.

Automatic service with full control—Once a loan is created, the system will notify the lender with the transaction details and follow up notifications regarding other events along the lifecycle of the loan. The lender will be able to track loans from a unique web based dashboard.

Deal management—The system will manage the loan and the collateral in favor and on behalf of the lenders and initiate changes in lending fees (re-rates) and collateral adjustments with the relevant counterparties, according to market events, corporate actions and changes in valuation of the loaned security and/or the collateral.

Loan termination: the following events that lead to the termination of a loan are described hereunder:

Lender recall request—the lender will be able to request a recall during the lifecycle of the loan. Once the lender placed a recall request, the system will notify the relevant counterparties and manage the recall process.

System Auto recall—if the lender chose the rules-based Auto Recall service, then the system will initiate the recall process upon materialization of one of the pre-defined rules.

Borrower return—a borrower may choose to return the loan at will.

System end of trade—the system may choose to terminate the loan at the occurrence of external pre-defined rules.

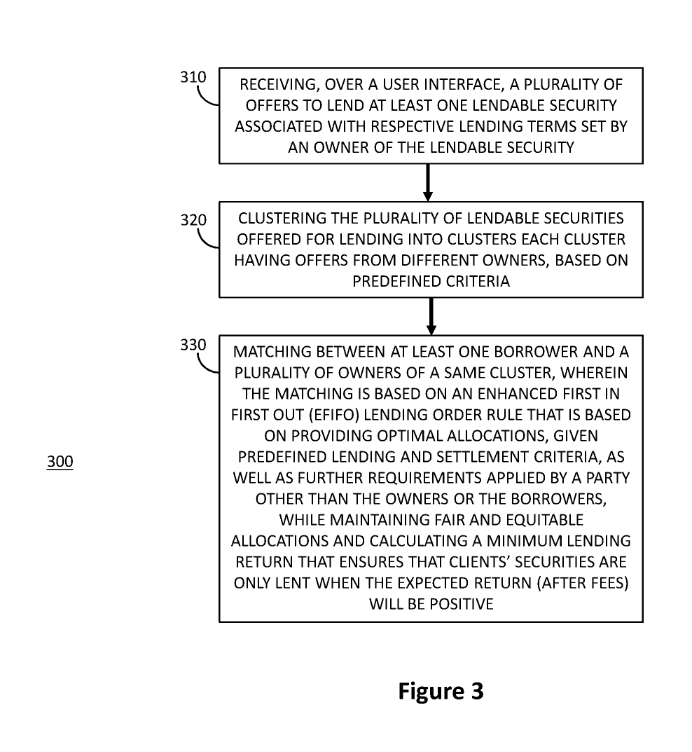

FIG. 3 is a high-level flowchart illustrating non-limiting exemplary method 300 of automatically generating securities' lending matches between individual investors and financial institutions in accordance with some embodiments of the present invention. Method 300 may be implemented by the aforementioned architecture described herein of system 100. However, it should be understood that a different hardware may be used to implement the steps of method 300 as follows. Method 300 may include: receiving, over a user interface, a plurality of offers to borrow at least one lendable security associated with respective lending terms set by an owner of the lendable security 310; clustering the plurality of lendable securities into clusters (each cluster having offers from different owners), to be made available for lending based on predefined criteria 320; and matching between at least one borrower and a plurality of owners of a same cluster, wherein the matching is based on an Enhanced First In First Out (EFIFO) lending order rule that is based on providing optimal allocations, given predefined lending and settlement criteria, as well as further requirements applied by a party other than the owners or the borrowers, while maintaining fair and equitable allocations and calculating a minimum lending return that ensures that clients' securities are only lent when the expected return (after fees) will be positive.

According to some embodiments of the present invention, the aforementioned method may be implemented over a non-transitory computer readable medium may include a set of instructions that when executed cause at least one processor to: receive, a plurality of offers to borrow at least one lendable security associated with respective lending terms set by an owner of the lendable security; cluster the plurality of lendable securities into clusters, each cluster having offers from different owners, based on predefined criteria; and match between at least one borrower and a plurality of owners of a same cluster.

Advantageously, some embodiments of the present invention improve the equality and fairness among lenders as they facilitate the access to investment tools that are not currently available for the retail investor and simplify and unify the process so as to create maximum value for individual investors.

According to some embodiments of the present invention, the non-transitory computer readable medium may further include a set of instructions that when executed cause at least one processor to: automatically establish a plurality of lending deals between the matched borrowers and the respective owners of the lendable securities of the cluster.

In order to implement the method according to some embodiments of the present invention, a computer processor may receive instructions and data from a read-only memory or a random access memory or both. At least one of aforementioned steps is performed by at least one processor associated with a computer. The essential elements of a computer are a processor for executing instructions and one or more memories for storing instructions and data. Generally, a computer will also include, or be operatively coupled to communicate with, one or more mass storage devices for storing data files. Storage modules suitable for tangibly embodying computer program instructions and data include all forms of non-volatile memory, including by way of example semiconductor memory devices, such as EPROM, EEPROM, and flash memory devices and also magneto-optic storage devices.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in base band or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wire-line, optical fiber cable, RF, etc., or any suitable combination of the foregoing.

The aforementioned flowchart and diagrams illustrate the architecture, functionality, and operation of possible implementations of systems, methods and computer program products according to various embodiments of the present invention. In this regard, each portion in the flowchart or portion diagrams may represent a module, segment, or portion of code, which comprises one or more executable instructions for implementing the specified logical function(s). It should also be noted that, in some alternative implementations, the functions noted in the portion may occur out of the order noted in the figures. For example, two portions shown in succession may, in fact, be executed substantially concurrently, or the portions may sometimes be executed in the reverse order, depending upon the functionality involved. It will also be noted that each portion of the portion diagrams and/or flowchart illustration, and combinations of portions in the portion diagrams and/or flowchart illustration, can be implemented by special purpose hardware-based systems that perform the specified functions or acts, or combinations of special purpose hardware and computer instructions.

In the above description, an embodiment is an example or implementation of the inventions. The various appearances of “one embodiment,” “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “some embodiments”, “an embodiment”, “one embodiment” or “other embodiments” means that a particular feature, structure, or characteristic described in connection with the embodiments is included in at least some embodiments, but not necessarily all embodiments, of the inventions.

It is to be understood that the phraseology and terminology employed herein is not to be construed as limiting and are for descriptive purpose only.

The principles and uses of the teachings of the present invention may be better understood with reference to the accompanying description, figures and examples.

It is to be understood that the details set forth herein do not construe a limitation to an application of the invention.

Furthermore, it is to be understood that the invention can be carried out or practiced in various ways and that the invention can be implemented in embodiments other than the ones outlined in the description above.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not being construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

The descriptions, examples, methods and materials presented in the claims and the specification are not to be construed as limiting but rather as illustrative only.

Meanings of technical and scientific terms used herein are to be commonly understood as by one of ordinary skill in the art to which the invention belongs, unless otherwise defined.

The present invention may be implemented in the testing or practice with methods and materials equivalent or similar to those described herein.

Any publications, including patents, patent applications and articles, referenced or mentioned in this specification are herein incorporated in their entirety into the specification, to the same extent as if each individual publication was specifically and individually indicated to be incorporated herein. In addition, citation or identification of any reference in the description of some embodiments of the invention shall not be construed as an admission that such reference is available as prior art to the present invention.

While the invention has been described with respect to a limited number of embodiments, these should not be construed as limitations on the scope of the invention, but rather as exemplifications of some of the preferred embodiments. Other possible variations, modifications, and applications are also within the scope of the invention. Accordingly, the scope of the invention should not be limited by what has thus far been described, but by the appended claims and their legal equivalents.

1. A method comprising:
receiving, over a user interface, a plurality of offers to borrow at least one lendable security associated with respective lending terms set by an owner of the lendable security;
clustering the plurality of lendable securities offered for borrowing into clusters, each cluster having offers from different owners, based on predefined criteria;
maximizing the potential value from securities lending of the owners' lendable securities by generating price requirements for the clustering of plurality of lendable securities offered for borrowing into clusters, each cluster having offers from different owners, based on predefined criteria; and
matching between at least one borrower and a plurality of owners of a same cluster, wherein the matching is based on an Enhanced First In First Out (EFIFO) lending order rule that is based on providing optimal allocations, given predefined lending and settlement criteria, as well as further requirements applied by a party other than the owners or the borrowers, while maintaining fair and equitable allocations and calculating a minimum lending return that ensures that clients' securities are only lent when the expected return after fees is positive.

2. The method according to claim 1, further comprising of automatically initiating a plurality of lending deals between the matched borrowers and the respective owners of the lendable securities of the cluster.

3. The method according to claim 1, wherein said lending terms comprise of at least minimal number of units; minimum lending rate; method of approving loan requests; and recall terms.

4. The method according to claim 1, wherein the collateral comprise at least one of: cash; government bonds; corporate bonds; equities; and Exchange Traded Funds.

5. A system comprising:
a user interface configured to receiving, a plurality of offers to borrow at least one lendable security associated with respective lending terms set by an owner of the lendable security;
a pricing module configured to maximize the potential value from securities lending of the owners' lendable securities by generating price requirements for the clustering of plurality of lendable securities offered for borrowing into clusters, each cluster having offers from different owners, based on predefined criteria; and
a matching engine configured to match between at least one borrower and a plurality of owners of a same cluster, wherein the matching is based on an Enhanced First In First Out (EFIFO) lending order rule that is based on providing optimal allocations, given predefined lending and settlement criteria, as well as further requirements applied by a party other than the owners or the borrowers, while maintaining fair and equitable allocations and calculating a minimum lending return that ensures that clients' securities are only lent when the expected return after fees is positive.

6. The system according to claim 5, further comprising a deal management module configured to automatically establish a plurality of lending deals between the matched borrowers and the respective owners of the lendable securities of the cluster.

7. The system according to claim 5, wherein maximizing the potential value from securities lending of the owners' lendable securities is achieved by applying a pricing function to the offered securities given the respective lending terms to yield scores associate with potential lending deals, and applying the matching based on the scores, to yield an overall maximum score of the lending deals.

8. The system according to claim 5, wherein said lending terms comprise of at least minimal number of units; minimum lending rate; method of approving loan requests; and recall terms.

9. The system according to claim 5, wherein the collateral comprise at least one of: cash; government bonds; corporate bonds; equities; and Exchange Traded Funds.

10. The system according to claim 5, wherein said further requirements comprise at least one of: minimal number of security lending units;

11. A non-transitory computer readable medium comprising a set of instructions that, when executed, cause at least one processor to:
receive a plurality of offers to borrow at least one lendable security associated with respective lending terms set by an owner of the lendable security;
cluster the plurality of lendable securities offered for borrowing into clusters each cluster having offers from different owners, based on predefined criteria;
maximize the potential value from securities lending of the owners' lendable securities by generating price requirements for the clustering of plurality of lendable securities offered for borrowing into clusters, each cluster having offers from different owners, based on predefined criteria; and
match between at least one borrower and a plurality of owners of a same cluster, wherein the matching is based on an Enhanced First In First Out (EFIFO) lending order rule that is based on providing optimal allocations, given predefined lending and settlement criteria, as well as further requirements applied by a party other than the owners or the borrowers, while maintaining fair and equitable allocations and calculating a minimum lending return that ensures that clients' securities are only lent when the expected return after fees is positive.

12. The non-transitory computer readable medium according to claim 11, further comprising a set of instructions that when executed cause at least one processor to: automatically establish a plurality of lending deals between the matched borrowers and the respective owners of the lendable securities of the cluster.

13. The non-transitory computer readable medium according to claim 11, wherein maximizing the potential value from securities lending of the owners' lendable securities is achieved by applying a pricing function to the offered securities given the respective lending terms to yield scores associate with potential lending deals, and applying the matching based on the scores, to yield an overall maximum score of the lending deals.

14. The non-transitory computer readable medium according to claim 11, wherein said lending terms comprise of at least minimal number of units; minimum lending rate; method of approving loan requests; and recall terms.

15. The non-transitory computer readable medium according to claim 11, wherein the collateral comprise at least one of: cash; government bonds; corporate bonds; equities; and Exchange Traded Funds.
